(19) United States
(12) Patent Application Publication
(10) Pub. No.: US 2002/0034887 A1
(43) Pub. Date: Mar. 21, 2002

(54) Device for contacting transmission of electrical signals by means of roll bodies

(76) Inventors: Kurt Dollhofer, Kaufbeuren (DE); Georg Lohr, Eichenau (DE)

Correspondence Address: ST. ONGE STEWARD JOHNSTON & REENS, LLC, 986 BEDFORD STREET, STAMFORD, CT, 06905-5619, US

(21) Appl. No.: 09/909,061

(22) Filed: Jul. 19, 2001

Related U.S. Application Data
(63) Continuation of application No. 09/667,063, filed on Sep. 21, 2000.

(51) Int. Cl. H01R 39/00

(52) U.S. Cl. 439/17

(57) ABSTRACT

What is described here is a device consisting of a first and a second part which parts are mobile relative to each other by a rotational or translational movement, as well as roll bodies in an axial, vertical or oblique direction between the two parts. The invention is based on the problem of ensuring a low-interference signal transmission immune to interference as well as a long service life of the transmission system. In particular, excessively great asymmetries are to be avoided.

The invention is distinguished by the aspect that the roll bodies cannot come into contact with both parts at the same time and that a bearing cage is not used so that the roll bodies are statistically distributed. Another inventive solution resides in a purposeful combination of several roll bodies which are purposefully so dimensioned that they cannot come into contact with both parts at the same time, with further roll bodies which are purposefully so dimensioned that they can come into contact with both parts at the same time, with the application of bearing cages being possible as well for a reduction of asymmetries. This provision permits a transmission of energy and information between both parts, a mechanical stabilisation of the inventive device, with the advantageous application also of parts having resilience properties.

### DESCRIPTION

The present invention relates to a device for transmitting electrical signals or energy, respectively, among a plurality of units mobile relative to each other.

For the sake of an easier understanding, a distinction between the transmission of units mobile relative to each other and a stationary unit and mobiles mobile relative to the latter is not made in this patent application because this is only a question of positional relationship and does not take any influence on the functionality of the present invention. Equally, a further distinction is not made between the transmission of signals and energy because the mechanisms of effect and action are the same in this respect.

In linearly mobile units such as crane and conveyor systems and also in rotatable units such as radar installations or also computer tomographs it is necessary to transmit electrical signals or energy between units mobile relative to each other or between a stationary unit and units disposed for mobility relative thereto, respectively.

In accordance with the U.S. Pat. No. 2,409,600 brushes are replaced by electrically conductive rolling elements. These rolling elements serve as electrical conductors. They move in a circular space between radially spaced inner and outer electrically conductive surfaces and are maintained at a relative spacing from each other by a cage in the periphery of the circular space, which consists preferably of an insulating material. The rolling elements establish an electrical connection between inner and outer surfaces.

There is the disadvantage that it is practically impossible to provide all the rolling elements with precisely the same diameter, as this is intended in this case, or to design the diameter to be precisely identical with the radial spacing between the inner and outer sections. This means that the diameter of the rolling elements is smaller than or equal to the radial spacing. This may lead so far that none of the rolling elements will actually contact both of the outer and inner surfaces. This results in two possible consequences:

When the rolling elements are spaced by an electrically insulating cage contact breaking may occur.

When the rolling elements are spaced from each other by an electrically conductive cage this design increases the electrical resistance of the electrical connection between the outer and inner surfaces substantially because this connection can now still be established only via the cage and a rolling element contacting the outer surface and via a rolling element contacting the inner surface.

The document WO 98/05104 discloses a brushless slip ring, using a stacked arrangement of electrically conducting rotor and stator rings, with electrically conductive rolling elements being disposed in the circular space therebetween. A cage is not used. The aforementioned components are so designed that the rolling elements fit into the space and are still arranged so close to each other and to the rings that an electrical connection via the rolling elements will always be ensured. The rolling elements are freely mobile within the space and are not resilient.

As many rolling elements are possible are used. In correspondence with the tolerances in manufacture not all of the rolling elements are in contact with both rings at the same time. As a result, the possibility is opened up, as a matter of fact, that the larger rolling elements contact the outer conductive surface while the smaller rolling elements press against the inner conductive surface and thus establish an electrical connection between the outer and inner surfaces.

The reason for this resides in the fact that the centres of gravity of the larger rolling elements present a wider distance from the axis of rotation than the centres of gravity of the smaller rolling elements. At the same angular speed their velocity is hence higher than the velocity of the smaller elements, which causes the pressing action.

As a consequence, however, due to this intensifying effect of the tolerances (on account of the calculation of the mass moment of inertia into which the radius of the second power is incorporated) of the rolling elements a substantial imbalance occurs with respect to the distribution of masses around the axis of rotation/axis of movement of the parts mobile relative to each other. Here accidental and non-purposeful distributions of masses of the rolling elements presenting tolerances is involved. These random asymmetries may result in an increased wear of the components up to their destruction. This occurs, for instance, in cases where high angular velocities or high accelerations or direct changes of direction must be provided. These asymmetries may likewise trigger vibration processes which take a detrimental influence on the sequence of the movements. A non-symmetrical succession of movements could, for instance, adulterate results measured at a computer tomograph.

The present invention is based on the problem of providing a device for non-contacting transmission of electrical signals in accordance with claims 1, 5, 10 and 18, which ensures a low-interference signal transmission immune to interference as well as a long service life of the transmission system at a low expenditure, thus overcoming the disadvantages deriving from the afore-discussed prior art. In particular, the service life is to be prolonged and the reliability is to be improved, both at a reduced contact noise.

This problem is solved by the means characterised in the claims 1, 2, 5, 10 and 18 and their respective dependent claims. With these provisions the effects described in the document WO 98/05104 are purposefully utilised, and hence utilised in a controlled manner, in order to avoid asymmetries in particular.

### ADVANTAGES OF THE INVENTION

These solutions furnish a mechanically stable structure without additional bearings. This means in particular that a bearing already existing may be used for energy transmission and the communication of information in an expedient manner in accordance with the invention if it is appropriately designed.

Compared against conventional contact systems with slip rings, in particular, the occurrence of abrasion caused by the rolling movement of the rolling elements is avoided.

Due to multiple contact points—a ball bearing with rigid bearing shells rests on three points (three balls) at maximum—the plane of the bearing guide is unambiguously defined and can be optimised in correspondence with the respectively intended application.

Due to the inventive embodiments, contact breaking is avoided. And equally, the electrical resistance between the rings is restricted to a maximum level which can be optimised for the respectively intended application of the inventive devices.

In particular, the inventive embodiments serve to avoid asymmetries due to statistical distribution of masses or a purposeful combination of rolling elements contacting and non-contacting the moved parts or due to the use of bearing cages for determination of an optimum distribution of masses. The latter aspect comes into consideration specifically when asymmetries, even though they are expedient, must be restricted to a defined extent.

As a result, a reduced wear, the avoidance of vibration processes, a smooth succession of movements between the mobile elements and hence optimum conditions of operations are achieved for the inventive devices.

Moreover, it is easily possible to produce roll bodies smaller than the space between the mobile elements. A precise dimensioning matched exactly with the space is hence no longer demanded. The dimensioning specifications are hence easy to satisfy. An electrical connection between mobile elements is ensured due to the statistical distribution of the roll bodies at very slight asymmetries.

In accordance with another embodiment at least as little as three further roll bodies are provided which are purposefully so dimensioned that they may come into contact with both mobile parts at the same time. This means that a respective specification is easier to realise for this limited number of roll bodies.

With a limited number of roll bodies contacting both parts it is possible to avoid asymmetries due to their purposeful well-balanced positioning relative to each other, whilst yet the mechanisms of the closest-coming prior art (WO 98/05104) can still be utilise. Due to at least three roll bodies coming into contact with both mobile parts at the same time, a plane is expediently defined in which the bearing is positioned. As a result of three resting points—which means three of these roll bodies—a plane is expediently defined without overdetermination.

When the spacings of the at least three further roll bodies from each other take different values asymmetries will occur in view of the distribution of masses, even though the contacting of the components (roll bodies mobile parts) is improved.

When the roll bodies are guided by a bearing cage the roll bodies are expediently spaced from each other in correspondence with the envisaged application of the device, and hence asymmetries are avoided or at least reduced in accordance with the present invention.

When the spacings of the at least three further roll bodies relative to each other are intended to be of different magnitudes it is hence possible to achieve a corresponding reduction of asymmetries by the guidance by means of the bearing cages.

A corresponding dimensioning of the components is possible also for roll bodies in a radial direction between the moved parts. In such a case, too, asymmetries are avoided or reduced, respectively, in correspondence with the intended application, by a purposeful appropriate selection of the number and the position of the roll bodies contacting both parts, relative to the roll bodies not contacting both parts at the same time. An electrical connection of the mobile parts is then always ensured (mechanism of effects in correspondence with WO 98/05104). According to the present invention, the dimensioning of roll bodies is limited to a predetermined number of roll bodes, so as to achieve a simultaneous contact of these two mobile parts, and therefore this design is comparatively easy to manage in engineering terms.

In this case, too, the plane in which the ball bearing is positioned is unambiguously determined by three roll bodies contacting with parts at the same time.

When certain asymmetries are desirable—e.g. for improving the contacting operations—they can be limited by bearing cages.

When at lest one part of the roll bodies is maintained at mutually defined spacings by means of a bearing cage asymmetries can be avoided.

The same applies also to the relative positioning of the roll bodies contacting both parts at the same time. In such a design all or only one part of these roll bodies may be dispose at a defined mutual spacing by means of the bearing cage.

In accordance with another inventive ideas, at least one of the mobile parts may present resilience properties or be provided in such a way that at least one roll body is pressed against the other mobile part. As a result, the electrical connection between the two mobile parts is additionally ensured. Asymmetries are also avoided by the homogeneous pressing of the elements thereagainst.

Such pressing action can be expediently achieved by means of particularly robust disk springs or Belleville spring washers.

When a bearing ring of resilient material is provided a separate spring is expediently avoided.

When the elements are pressed it is expedient that all roll bodies are designed to have the same size so as to provide for a uniform distribution of the pressure acting upon the roll bodies.

When the roll bodies are guided by a bearing cage when they are pressed their relative positioning can be further optimised in view of asymmetries in particular.

It is moreover expedient in a pressing-action solution to use as few roll bodies as possible so that the bearing ring, which consists of a resilient material, may be elastically deformed between the roll bodies. This provision further improves the electrical connection between the mobile parts. The minimum number is two, three roll bodies are the optimum.

There is a possibility to provide at least two larger roll bodies in the provision of the inventive devices, which define expediently the spacing of the parts mobile relative to each other. Here, too, bearing cages are provided for avoiding asymmetries.

This means that in such a case as well the larger roll bodies can be positioned relative to each other in an optimum manner by means of a bearing cage.

It is equally possible to design one of the mobile parts to have resilience properties. A resilient metal sheet is advantageous as replacement of a less robust spring at a lower expenditure.

When all the roll bodies have the same size the pressure is homogeneously distributed by the spring in an expedient manner.

On account of their mechanical properties, inter alia, highly conducting metals such as gold or silver are particularly well suitable as the material to be used for the roll bodies and mobile parts. A gold or silver coating applied on steel permits an optimisation in terms of mechanical robustness and a very good electrical conductivity as well.

When the material of the roll bodies is harder than the material of the parts mobile relative to each other an optimum adaptation of the shape of the roll bodies to the surfaces of the parts mobile relative to each other is expediently achieved in the region where the roll bodies contact the mobile parts.

The bearing rings, too, may be provided in terms of material in correspondence with the roll bodies or the mobile parts.

As has been mentioned by way of introduction, the inventive devices are expediently employed for a contacting transmission of electrical signals and/or energy between at least two parts mobile relative to each other.

The invention will be described in the following by way of exemplary embodiments, without any restriction of the general inventive idea, with reference to the drawing which reference is made to expressis verbis in all other respects as far as the disclosure of all inventive details is concerned which are not explained in more details in the text. In the drawing:

FIG. 1: shows an inventive embodiment of an axial arrangement;

FIG. 2: illustrates an inventive embodiment of an axial arrangement with three roll bodies for stabilising the axial spacing;

FIG. 3: is a view of an inventive embodiment of an axial arrangement including several roll bodies for stabilising the axial spacing;

FIG. 4: shows an inventive embodiment of an axial arrangement with three roll bodies in the bearing cage for stabilising the axial spacing;

FIG. 5: illustrates an inventive embodiment of a radial arrangement including three roll bodies for stabilising the axial spacing;

FIG. 6: shows an inventive embodiment of a radial arrangement including three roll bodies in the bearing cage for stabilising the radial spacing;

FIG. 7: is a view of an inventive embodiment with an axial arrangement, which includes a rotating element with resilience properties;

FIG. 8: is a view of an inventive embodiment including a multi-channel system;

FIG. 9: shows an inventive embodiment of an oblique arrangement, including an inner Belleville spring washer;

FIG. 10: is a view of an inventive embodiment of an oblique arrangement, including an outer Belleville spring washer;

FIG. 11: shows an inventive embodiment of a radial arrangement, including inner Belleville spring washers;

FIG. 12: is a view of an inventive embodiment presenting a radial arrangement with a resilience characteristic;

FIG. 13: is a view of an inventive embodiment including a radial arrangement with a resilient mobile part and a minimum number of roll bodies;

FIG. 14: illustrates an inventive embodiment of a radial arrangement with cylindrical rollers;

FIG. 15: is a view of an inventive embodiment of a coaxial arrangement of the axial design, and

FIG. 16: illustrates an inventive embodiment of the movement of the roll bodies.

### The drawings represent defined embodiments which can be realised, on principle, also with shapes of roll bodies other than those illustrated here.

Embodiments:

FIG. 1 is an exemplary representation of an axial embodiment of the invention. In the space between the two rotating parts (1) and (2) the roll bodies are provided which are illustrated here in the form of balls (3). These bodies are slightly smaller than the spacing between the rotating parts. Due to a rotation of the parts relative to each other the balls hit against each other as well as against the two rotatable parts. Hence an electrical connection with is created between the rotating parts at different locations the same time via two respective balls. Here the case applies that the diameter of the balls (3) is smaller than the spacing of the two parts.

FIG. 2 illustrates an example of an axial arrangement based on FIG. 1. In addition, however, three larger roll bodies (4) are provided expediently for stabilising the axial spacing between the first and second parts which are mobile relative to each other for performing a rotational or translational movement. It is also possible, however, to provide more than three larger roll bodies (4). Stabilisation is here achieved in particular by the provision that the diameter of the rolling balls corresponds, for instance, to the spacing between the two parts (diameter=spacing).

FIG. 3 is an exemplary representation of an axial arrangement including five larger roll bodies (4) for stabilising the axial spacing. Here, the spacings of the roll bodies (4), i.e. the number of the roll bodies having smaller dimensions than the spacing between the rotating parts, are preferably designed to be of different magnitudes such that resonance phenomena will be attenuated in operation.

FIG. 4 shows the example of an axial arrangement including three larger roll bodies (4) for stabilising the axial spacing. To keep the roll bodies (4) at a respective defined spacing from each other they are contained in a bearing cage (5). In such a design the respective defined spacing of the roll bodies (4) relative to each other may be equal but also different. A number of larger roll bodies (4) which is higher than three is equally conceivable.

FIG. 5 shows the example of a radial arrangement consisting of the two rotating parts (1) and (2) with three larger roll bodies (4) for stabilising the radial spacing, as well as several smaller roll bodies (3) disposed therebetween.

FIG. 6 is an exemplary view of a radial arrangement including three larger roll bodies (4) for stabilising the radial spacing. The roll bodies (4) are disposed in a bearing cage (5) so a to maintain them at a respective defined spacing.

FIG. 7 shows the example of an axial arrangement including a rigid rotating part (1) as well as a rotating part having resilience properties (2). As is illustrated here, this rigid part may consist of a spring steel sheet.

When a bearing ring made of a resilient material is used as few roll bodies as possible should be used so that the bearing ring may be resiliently deformed between the roll bodies.

FIG. 8 illustrates a particularly expedient embodiment for transmitting several signals, which is designed by a plain stacking of the unit shown in FIG. 7. This means that several signals can be transmitted in parallel while they are electrically separated from each other, in particular.

FIG. 9 represents an example of an oblique arrangement including a rigid rotating part (1) as well as a rotating part having resilience properties (2). As is illustrated here, this part can be preferably realised in the form of a Belleville spring washer. In this case, the spring washer is located inside.

FIG. 10 is an exemplary view of an oblique arrangement including a rigid rotating part (1) as well as a rotating part having resilience properties (2). As is illustrated here, this part can be preferably realised in the form of a Belleville spring washer. In this case, the spring washer is located outside.

FIG. 11 shows an example of a radial arrangement including a rigid rotating part (1) as well as a rotating part having resilience properties. As is illustrated here, this part can preferably be realised by means of two Belleville spring washers (2a) and (2b).

FIG. 12 illustrates an example of a radial arrangement comprising a rigid rotating part (1) as well as a rotating part (2) having resilience properties. Three large roll bodies (4), which are guided by the cage (5), are slightly larger than the rated difference between the inside diameter of the resilient mobile part (2) and the outside diameter of the rigid mobile part 1. As a result, the resilient mobile part (2) is biased. Freely movable smaller roll bodies (3) ensure an additional contact.

FIG. 13 shows an arrangement as described with reference to FIG. 12. Here, however, the additional roll bodies have been dispensed with. The small number of roll bodies (4) is sufficient already for a proper contact.

FIG. 14 illustrates the embodiment of a radial arrangement including cylindrical rollers. Other types of roll bodies are equally conceivable.

FIG. 15 shows an axial arrangement wherein two sets of roll bodies are employed. The two sets of roll bodies (3) and (7) are disposed in coaxial relationship. With such a design it is possible, for instance, to transmit two signals at the same time. When one set of roll bodies is dimensioned exclusively like a ball bearing it is able to guide the unit precisely and is not used for signal transmission. The second set of roll bodies may then be used for signal transmission as before.

FIG. 16 illustrates the principle of the electrical connection via at least two balls.

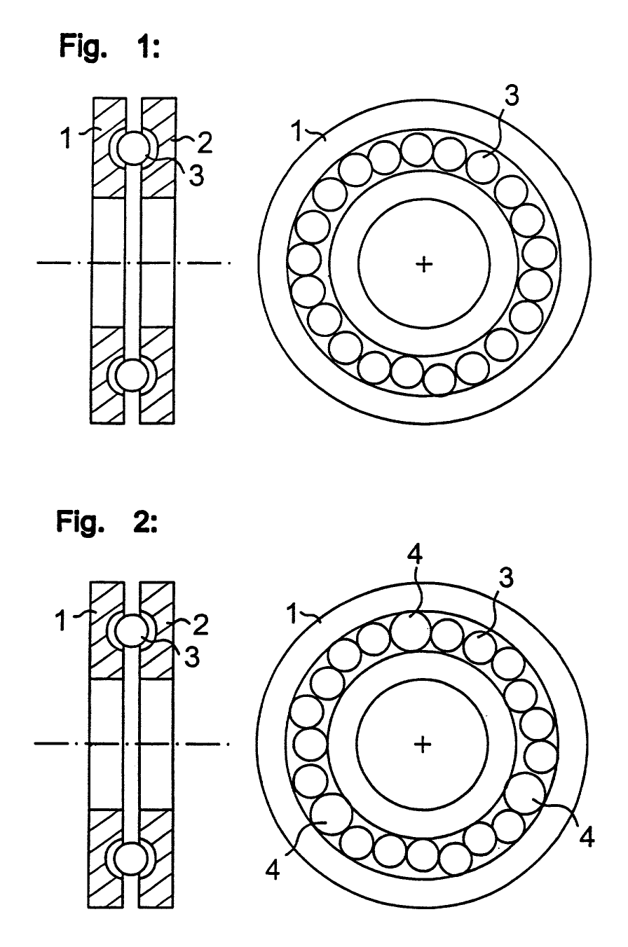

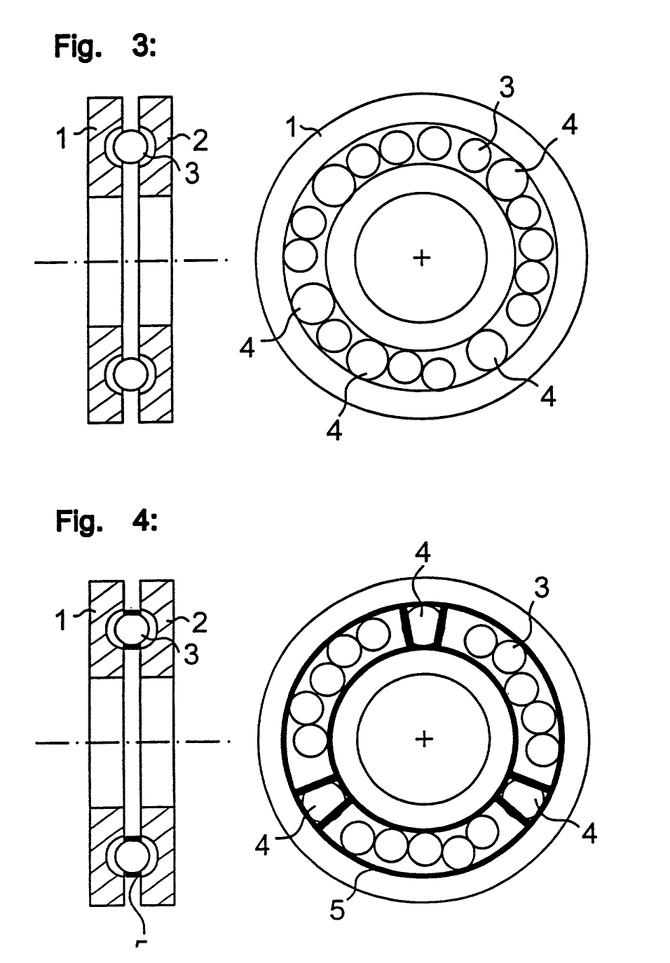

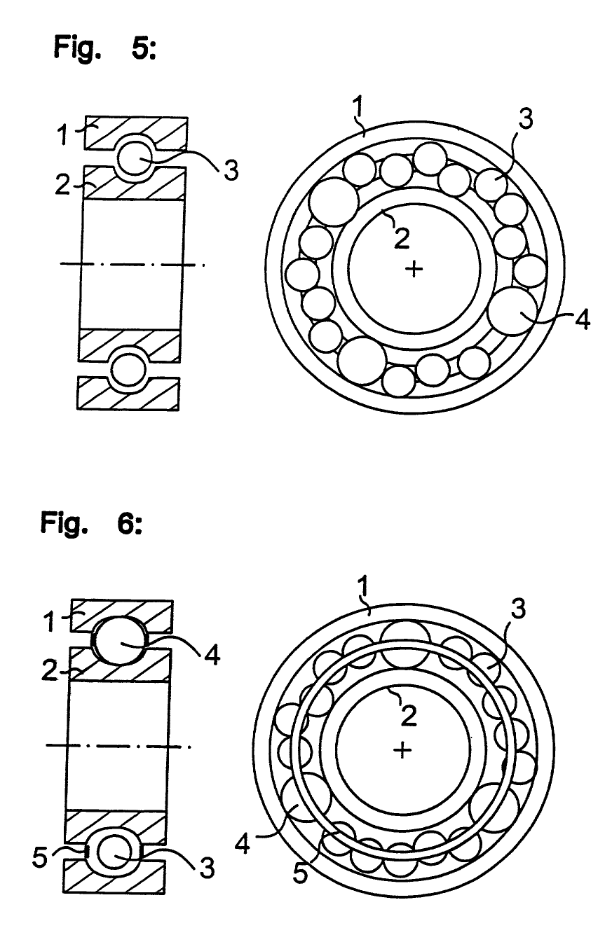

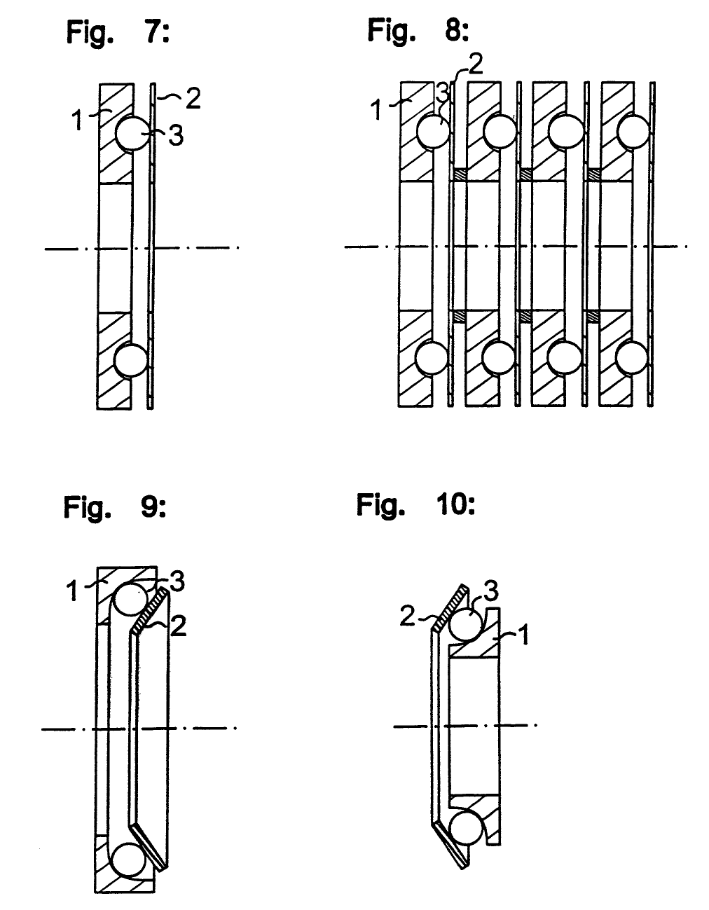

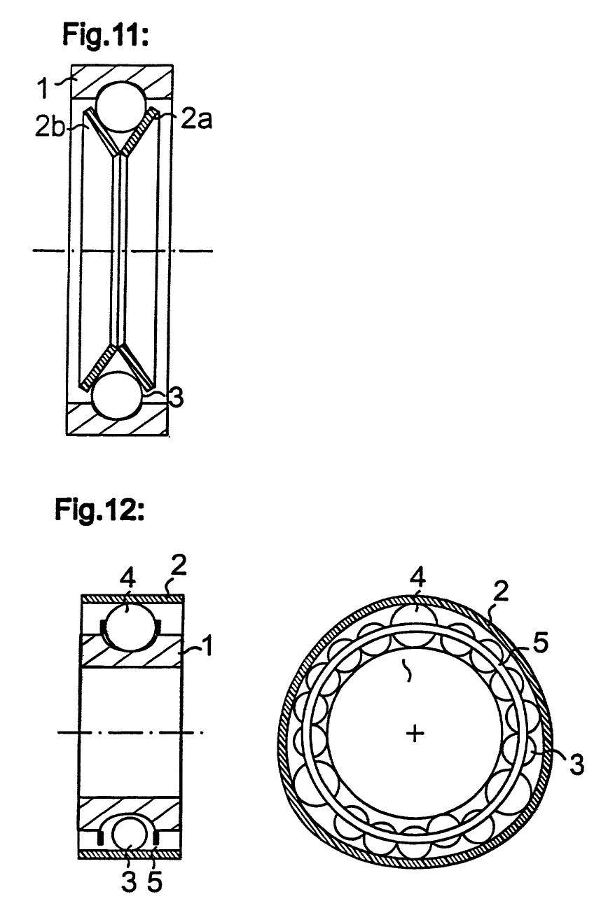

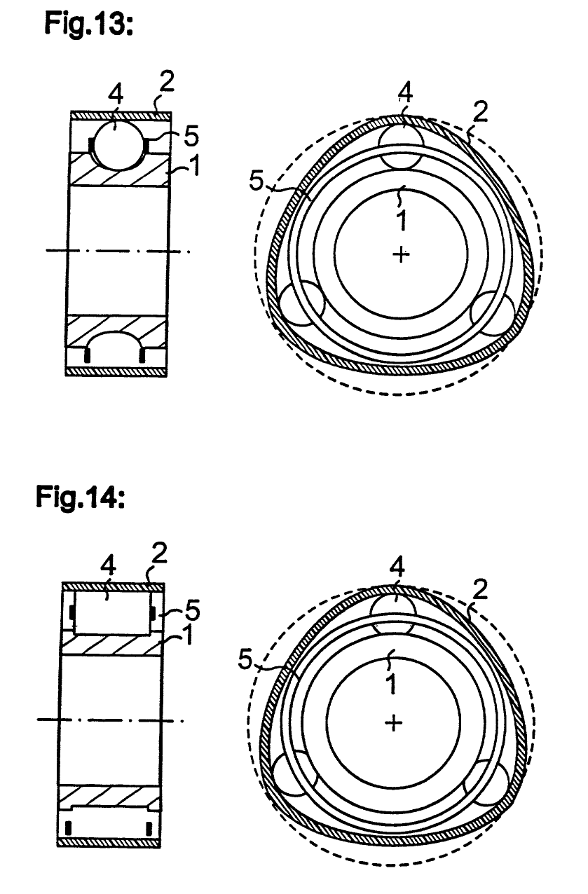

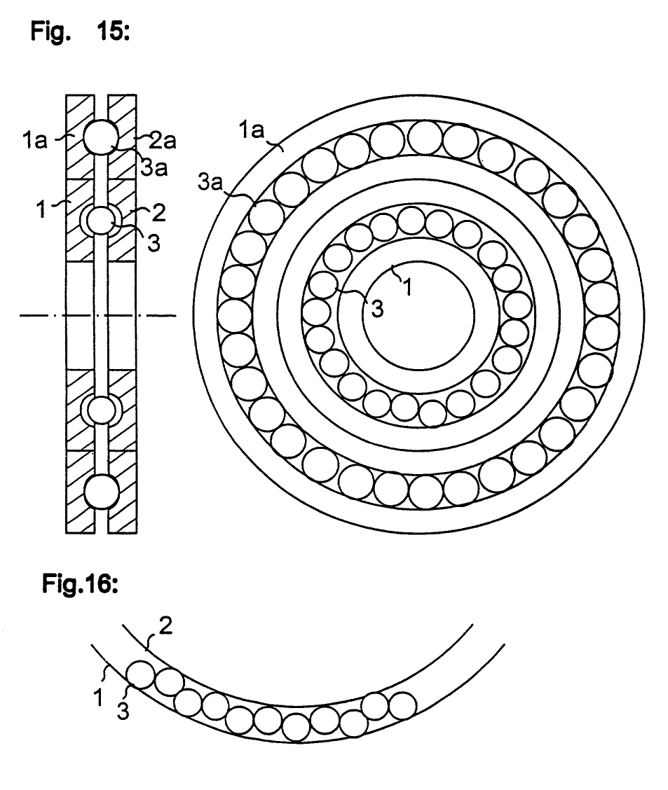

1. Device consisting of a first and a second part (1, 2), which parts are mobile relative to each other by a rotational or translational movement, as well as roll bodies (3) in an axial, vertical or oblique direction between said two parts, characterized in that said roll bodies (3) are purposefully so dimensioned that they cannot come into contact with both parts at the same time.

2. Device consisting of a first and a second part (1, 2), which parts are mobile relative to each other by a rotational or translational movement, as well as roll bodies (3) in an axial, vertical or oblique direction between said two parts, characterised in that said roll bodies (3) are purposefully so dimensioned that they cannot come into contact with both parts at the same time, and that at least three further roll bodies (4) are purposefully so dimensioned that they can come into contact with both parts at the same time.

3. Device according to claim 2,
characterised in that the spacings by which said at least three further roll bodies (4) are spaced from each other are of different magnitudes.

4. Device according to claim 2 or 3,
characterised in that said at least three further roll bodies are guided by a bearing cage (5).

5. Device consisting of a first and a second part (1, 2), which parts are mobile relative to each other by a rotational or translational movement, as well as roll bodies (3) in an axial, radial, vertical, horizontal or oblique direction between said two parts,
characterised in that said roll bodies (3) are purposefully so dimensioned that they will not come into contact with both parts at the same time, and that at least three further roll bodies (4) are purposefully so dimensioned that they can come into contact with both parts at the same time.

6. Device according to any of the claims 5,
characterised in that the spacings by which said at least three further roll bodies (4) are spaced from each other are of different magnitudes.

7. Device according to claim 5 or 6,
characterised in that at least one part of roll bodies (3, 4) is maintained at relative defined spacings from each other by said bearing cage (5).

8. Device according to claim 5 or 6,
characterised in that at least one part of said at least three further roll bodies (4) is maintained at relative defined spacings from each other by said bearing cage (5).

9. Device according to claim 5 or 6,
characterised in that said at least three further roll bodies (4) are maintained at relative defined spacings from each other by said bearing cage (5).

10. Device consisting of a first and a second part (1, 2), which parts are mobile relative to each other by a rotational or translational movement, as well as roll bodies (3) in an axial, radial, vertical, horizontal or oblique direction between said two parts,
characterised in that at least one of said mobile parts presents resilience properties or consists of a resilient material, respectively, which is uniformly pressed via a spring and which is so dimensioned that it presses at least one roll body against the other part.

11. Device according to claim 10,
characterised in that the pressing action is created by a Belleville spring washer or by a round resilient metal sheet in an axial or oblique direction.

12. Device according to claim 10,
characterised in that the pressing action is created by a bearing ring consisting of a resilient material.

13. Device according to any of the claims 10 to 12,
characterised in that all roll bodies have the same size.

14. Device according to any of the claims 10 to 13,
characterised in that all roll bodies are uniformly pressed.

15. Device according to any of the claims 10 to 14,
characterised in that said roll bodies are guided by a bearing cage.

16. Device according to any of the claims 10 to 15,
characterised in that in a radial arrangement at least two roll bodies are provided.

17. Device according to any of the claims 10 to 16,
characterised in that in a radial arrangement three roll bodies are provided.

18. Device consisting of a first and a second part, which parts are mobile relative to each other by a rotational or translational movement, as well as roll bodies (3) between said parts,
characterised in that several roll bodies are purposefully so dimensioned that they cannot come into contact with both parts at the same time.

19. Device according to claim 18,
characterised in that at least two roll bodies are purposefully dimensioned to be larger than the other roll bodies, thus defining the spacing between said parts mobile relative to each other.

20. Device according to claim 19,
characterised in that said larger roll bodies are guided by means of a bearing cage.

21. Device according to claims 18 to 20,
characterised in that one of said parts presents resilience properties.

22. Device according to claim 21,
characterised in that said part having the resilience properties is pressed by a resilient metal sheet.

23. Device according to any of the claims 18 to 12,
characterised in that all roll bodies have the same size.

24. Device according to any of the claims 21 to 23,
characterised in that due to the pressing of the part having resilience properties all roll bodies are uniformly pressed.

25. Device according to any of the claims 1 to 24,
characterised in that said roll bodies comprise a well conducting material such as gold and/or silver.

26. Device according to any of the claims 1 to 25,
characterised in that said parts mobile relative to each other comprise a well conducting material such as gold and/or silver.

27. Device according to any of the claims 1 to 26,
characterised in that said roll bodies consist of a hard material such as steel and comprise a coating of a well conducting material such as gold and/or silver.

28. Device according to any of the claims 1 to 27,
characterised in that said parts mobile relative to each other consist of a hard material such as steel and comprise a coating of a well conducting material such as gold and/or silver.

29. Device according to any of the claims 1 to 28,
characterised in that the material of said roll bodies is harder than the material of said parts mobile relative to each other.

30. Device according to any of the claims 4, 7, 8, 9, 15 or 20,
characterised in that said bearing cage comprises a well conducting material such as gold and/or silver.

31. Device according to any of the claims 4, 7, 8, 9, 15, 20 or 30,
characterised in that said bearing cage consists of a hard material such as steel and comprises a coating of a well conducting material such as gold and/or silver.

32. Application of a device according to any of the claims 1 to 28 for the contacting transmission of electrical signals and/or energy between at least two parts mobile relative to each other.
